(19) United States
(12) Patent Application Publication
(10) Pub. No.: US 2005/0206346 A1
(43) Pub. Date: Sep. 22, 2005

(54) Battery charger with automatic customer notification system

(75) Inventors: Clark E. Smith, Oswego, IL (US); Kevin I. Bertness, Batavia, IL (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Midtronics, Inc., Willowbrook, IL (US)

(21) Appl. No.: 10/804,402

(22) Filed: Mar. 18, 2004

(51) Int. Cl. H02J 7/00

(52) U.S. Cl. 320/132

(57) ABSTRACT

A battery charger with an automatic customer notification system is provided. The battery charger includes battery charging circuitry which is configured to couple to a battery, and to provide a charging signal to the battery. The battery charger also includes communication circuitry, coupled to the charging circuitry, that is configured to transmit a signal to an external device upon receipt of a charge status code form the battery charging circuitry.

### BACKGROUND OF THE INVENTION

The present invention relates to rechargeable storage batteries. More specifically, the present invention relates to charging such storage batteries.

Chemical batteries which create electricity from chemical reactions have been known for many years. Such batteries are becoming increasingly important and have found uses throughout industry. These uses include automobiles, UPS systems, etc.

One advantage of chemical batteries, such as lead acid storage batteries, is that they can be charged and the chemical process reversed by forcing electricity through the battery. Charging systems are widely known in the art and are widely available in the consumer market. Some charging systems include both battery charging and battery testing circuitry and are therefore capable of determining the battery condition before, during and after battery charging.

Various examples of battery chargers and testers are described in U.S. Pat. No. 3,873,911, issued Mar. 25, 1975, to Champlin, entitled ELECTRONIC BATTERY TESTING DEVICE; U.S. Pat. No. 3,909,708, issued Sep. 30, 1975, to Champlin, entitled ELECTRONIC BATTERY TESTING DEVICE; U.S. Pat. No. 4,816,768, issued Mar. 28, 1989, to Champlin, entitled ELECTRONIC BATTERY TESTING DEVICE; U.S. Pat. No. 4,825,170, issued Apr. 25, 1989, to Champlin, entitled ELECTRONIC BATTERY TESTING DEVICE WITH AUTOMATIC VOLTAGE SCALING; U.S. Pat. No. 4,881,038, issued Nov. 14, 1989, to Champlin, entitled ELECTRONIC BATTERY TESTING DEVICE WITH AUTOMATIC VOLTAGE SCALING TO DETERMINE DYNAMIC CONDUCTANCE; U.S. Pat. No. 4,912,416, issued Mar. 27, 1990, to Champlin, entitled ELECTRONIC BATTERY TESTING DEVICE WITH STATE-OF-CHARGE COMPENSATION; U.S. Pat. No. 5,140,269, issued Aug. 18, 1992, to Champlin, entitled ELECTRONIC TESTER FOR ASSESSING BATTERY/CELL CAPACITY; U.S. Pat. No. 5,343,380, issued Aug. 30, 1994, entitled METHOD AND APPARATUS FOR SUPPRESSING TIME VARYING SIGNALS IN BATTERIES UNDERGOING CHARGING OR DISCHARGING; U.S. Pat. No. 5,572,136, issued Nov. 5, 1996, entitled ELECTRONIC BATTERY TESTER WITH AUTOMATIC COMPENSATION FOR LOW STATE-OF-CHARGE; U.S. Pat. No. 5,574,355, issued Nov. 12, 1996, entitled METHOD AND APPARATUS FOR DETECTION AND CONTROL OF THERMAL RUNAWAY IN A BATTERY UNDER CHARGE; U.S. Pat. No. 5,585,416, issued Dec. 10, 1996, entitled APPARATUS AND METHOD FOR STEP-CHARGING BATTERIES TO OPTIMIZE CHARGE ACCEPTANCE; U.S. Pat. No. 5,585,728, issued Dec. 17, 1996, entitled ELECTRONIC BATTERY TESTER WITH AUTOMATIC COMPENSATION FOR LOW STATE-OF-CHARGE; U.S. Pat. No. 5,589,757, issued Dec. 31, 1996, entitled APPARATUS AND METHOD FOR STEP-CHARGING BATTERIES TO OPTIMIZE CHARGE ACCEPTANCE; U.S. Pat. No. 5,592,093, issued Jan. 7, 1997, entitled ELECTRONIC BATTERY TESTING DEVICE LOOSE TERMINAL CONNECTION DETECTION VIA A COMPARISON CIRCUIT; U.S. Pat. No. 5,598,098, issued Jan. 28, 1997, entitled ELECTRONIC BATTERY TESTER WITH VERY HIGH NOISE IMMUNITY; U.S. Pat. No. 5,656,920, issued Aug. 12, 1997, entitled METHOD FOR OPTIMIZING THE CHARGING LEAD-ACID BATTERIES AND AN INTERACTIVE CHARGER; U.S. Pat. No. 5,757,192, issued May 26, 1998, entitled METHOD AND APPARATUS FOR DETECTING A BAD CELL IN A STORAGE BATTERY; U.S. Pat. No. 5,821,756, issued Oct. 13, 1998, entitled ELECTRONIC BATTERY TESTER WITH TAILORED COMPENSATION FOR LOW STATE-OF-CHARGE; U.S. Pat. No. 5,831,435, issued Nov. 3, 1998, entitled BATTERY TESTER FOR JIS STANDARD; U.S. Pat. No. 5,914,605, issued Jun. 22, 1999, entitled ELECTRONIC BATTERY TESTER; U.S. Pat. No. 5,945,829, issued Aug. 31, 1999, entitled MIDPOINT BATTERY MONITORING; U.S. Pat. No. 6,002,238, issued Dec. 14, 1999, entitled METHOD AND APPARATUS FOR MEASURING COMPLEX IMPEDANCE OF CELLS AND BATTERIES; U.S. Pat. No. 6,037,751, issued Mar. 14, 2000, entitled APPARATUS FOR CHARGING BATTERIES; U.S. Pat. No. 6,037,777, issued Mar. 14, 2000, entitled METHOD AND APPARATUS FOR DETERMINING BATTERY PROPERTIES FROM COMPLEX IMPEDANCE/ADMITTANCE; U.S. Patent No. 6,051,976, issued Apr. 18, 2000, entitled METHOD AND APPARATUS FOR AUDITING A BATTERY TEST; U.S. Pat. No. 6,081,098, issued Jun. 27, 2000, entitled METHOD AND APPARATUS FOR CHARGING A BATTERY; U.S. Pat. No. 6,091,245, issued Jul. 18, 2000, entitled METHOD AND APPARATUS FOR AUDITING A BATTERY TEST; U.S. Pat. No. 6,104,167, issued Aug. 15, 2000, entitled METHOD AND APPARATUS FOR CHARGING A BATTERY; U.S. Pat. No. 6,137,269, issued Oct. 24, 2000, entitled METHOD AND APPARATUS FOR ELECTRONICALLY EVALUATING THE INTERNAL TEMPERATURE OF AN ELECTROCHEMICAL CELL OR BATTERY; U.S. Pat. No. 6,163,156, issued Dec. 19, 2000, entitled ELECTRICAL CONNECTION FOR ELECTRONIC BATTERY TESTER; U.S. Pat. No. 6,172,483, issued Jan. 9, 2001, entitled METHOD AND APPARATUS FOR MEASURING COMPLEX IMPEDANCE OF CELL AND BATTERIES; U.S. Pat. No. 6,172,505, issued Jan. 9, 2001, entitled ELECTRONIC BATTERY TESTER; U.S. Pat. No. 6,222,369, issued Apr. 24, 2001, entitled METHOD AND APPARATUS FOR DETERMINING BATTERY PROPERTIES FROM COMPLEX IMPEDANCE/ADMITTANCE; U.S. Pat. No. 6,225,808, issued May 1, 2001, entitled TEST COUNTER FOR ELECTRONIC BATTERY TESTER; U.S. Pat. No. 6,249,124, issued Jun. 19, 2001, entitled ELECTRONIC BATTERY TESTER WITH INTERNAL BATTERY; U.S. Pat. No. 6,259,254, issued Jul. 10, 2001, entitled APPARATUS AND METHOD FOR CARRYING OUT DIAGNOSTIC TESTS ON BATTERIES AND FOR RAPIDLY CHARGING BATTERIES; U.S. Pat. No. 6,262,563, issued Jul. 17, 2001, entitled METHOD AND APPARATUS FOR MEASURING COMPLEX ADMITTANCE OF CELLS AND BATTERIES; U.S. Pat. No. 6,294,896, issued Sep. 25, 2001; entitled METHOD AND APPARATUS FOR MEASURING COMPLEX SELF-IMMITANCE OF A GENERAL ELECTRICAL ELEMENT; U.S. Pat. No. 6,294,897, issued Sep. 25, 2001, entitled METHOD AND APPARATUS FOR ELECTRONICALLY EVALUATING THE INTERNAL TEMPERATURE OF AN ELECTROCHEMICAL CELL OR BATTERY; U.S. Pat. No. 6,304,087, issued Oct. 16, 2001, entitled APPARATUS FOR CALIBRATING ELECTRONIC BATTERY TESTER; U.S. Pat. No. 6,310,481, issued Oct. 30, 2001, entitled ELECTRONIC BATTERY TESTER; U.S. Pat. No. 6,313,607, issued Nov. 6, 2001, entitled METHOD AND APPARATUS FOR EVALUATING STORED CHARGE IN AN ELECTROCHEMICAL CELL OR BATTERY; U.S. Pat. No. 6,313,608, issued Nov. 6, 2001, entitled METHOD AND APPARATUS FOR CHARGING A BATTERY; U.S. Pat. No. 6,316,914, issued Nov. 13, 2001, entitled TESTING PARALLEL STRINGS OF STORAGE BATTERIES; U.S. Pat. No. 6,323,650, issued Nov. 27, 2001, entitled ELECTRONIC BATTERY TESTER; U.S. Pat. No. 6,329,793, issued Dec. 11, 2001, entitled METHOD AND APPARATUS FOR CHARGING A BATTERY; U.S. Pat. No. 6,331,762, issued Dec. 18, 2001, entitled ENERGY MANAGEMENT SYSTEM FOR AUTOMOTIVE VEHICLE; U.S. Pat. No. 6,332,113, issued Dec. 18, 2001, entitled ELECTRONIC BATTERY TESTER; U.S. Pat. No. 6,351,102, issued Feb. 26, 2002, entitled AUTOMOTIVE BATTERY CHARGING SYSTEM TESTER; U.S. Pat. No. 6,359,441, issued Mar. 19, 2002, entitled ELECTRONIC BATTERY TESTER; U.S. Pat. No. 6,363,303, issued Mar. 26, 2002, entitled ALTERNATOR DIAGNOSTIC SYSTEM, U.S. Pat. No. 6,392,414, issued May 21, 2002, entitled ELECTRONIC BATTERY TESTER; U.S. Pat. No. 6,417,669, issued Jul. 9, 2002, entitled SUPPRESSING INTERFERENCE IN AC MEASUREMENTS OF CELLS, BATTERIES AND OTHER ELECTRICAL ELEMENTS; U.S. Pat. No. 6,424,158, issued Jul. 23, 2002, entitled APPARATUS AND METHOD FOR CARRYING OUT DIAGNOSTIC TESTS ON BATTERIES AND FOR RAPIDLY CHARGING BATTERIES; U.S. Pat. No. 6,441,585, issued Aug. 17, 2002, entitled APPARATUS AND METHOD FOR TESTING RECHARGEABLE ENERGY STORAGE BATTERIES; U.S. Pat. No. 6,445,158, issued Sep. 3, 2002, entitled VEHICLE ELECTRICAL SYSTEM TESTER WITH ENCODED OUTPUT; U.S. Pat. No. 6,456,045, issued Sep. 24, 2002, entitled INTEGRATED CONDUCTANCE AND LOAD TEST BASED ELECTRONIC BATTERY TESTER; U.S. Pat. No. 6,466,025, issued Oct. 15, 2002, entitled ALTERNATOR TESTER; U.S. Pat. No. 6,466,026, issued Oct. 15, 2002, entitled PROGRAMMABLE CURRENT EXCITER FOR MEASURING AC IMMITTANCE OF CELLS AND BATTERIES; U.S. Pat. No. 6,534,993, issued Mar. 18, 2003, entitled ELECTRONIC BATTERY TESTER; U.S. Pat. No. 6,544,078, issued Apr. 8, 2003, entitled BATTERY CLAMP WITH INTEGRATED CURRENT SENSOR; U.S. Pat. No. 6,556,019, issued Apr. 29, 2003, entitled ELECTRONIC BATTERY TESTER; U.S. Pat. No. 6,566,883, issued May 20, 2003, entitled ELECTRONIC BATTERY TESTER; U.S. Pat. No. 6,586,941, issued Jul. 1, 2003, entitled BATTERY TESTER WITH DATABUS; U.S. Pat. No. 6,597,150, issued Jul. 22, 2003, entitled METHOD OF DISTRIBUTING JUMP-START BOOSTER PACKS; U.S. Pat. No. 6,621,272, issued Sep. 16, 2003, entitled PROGRAMMABLE CURRENT EXCITER FOR MEASURING AC IMMITTANCE OF CELLS AND BATTERIES, U.S. Pat. No. 6,623,314, issued Sep. 23, 2003, entitled KELVIN CLAMP FOR ELECTRICALLY COUPLING TO A BATTERY CONTACT, U.S. Pat. No. 6,633,165, issued Oct. 14, 2003, entitled IN-VEHICLE BATTERY MONITOR, U.S. Pat. No. 6,635,974, issued Oct. 21, 2003, entitled SELF-LEARNING POWER MANAGEMENT SYSTEM AND METHOD, U.S. Ser. No. 09/780,146,filed Feb. 9, 2001, entitled STORAGE BATTERY WITH INTEGRAL BATTERY TESTER; U.S. Ser. No. 09/756,638, filed Jan. 8, 2001, entitled METHOD AND APPARATUS FOR DETERMINING BATTERY PROPERTIES FROM COMPLEX IMPEDANCE/ADMITTANCE; U.S. Ser. No. 09/862,783, filed May 21, 2001, entitled METHOD AND APPARATUS FOR TESTING CELLS AND BATTERIES EMBEDDED IN SERIES/PARALLEL SYSTEMS; U.S. Ser. No. 09/908,278, filed Jul. 18, 2001, entitled BATTERY CLAMP WITH EMBEDDED ENVIRONMENT SENSOR; U.S. Ser. No. 09/880,473, filed Jun. 13, 2001; entitled BATTERY TEST MODULE; U.S. Ser. No. 09/940,684, filed Aug. 27, 2001, entitled METHOD AND APPARATUS FOR EVALUATING STORED CHARGE IN AN ELECTROCHEMICAL CELL OR BATTERY; U.S. Ser. No. 60/330,441, filed Oct. 17, 2001, entitled ELECTRONIC BATTERY TESTER WITH RELATIVE TEST OUTPUT; U.S. Ser. No. 60/348,479, filed Oct. 29, 2001, entitled CONCEPT FOR TESTING HIGH POWER VRLA BATTERIES; U.S. Ser. No. 10/046,659, filed Oct. 29, 2001, entitled ENERGY MANAGEMENT SYSTEM FOR AUTOMOTIVE VEHICLE; U.S. Ser. No. 09/993,468, filed Nov. 14, 2001, entitled KELVIN CONNECTOR FOR A BATTERY POST; U.S. Ser. No. 09/992,350, filed Nov. 26, 2001, entitled ELECTRONIC BATTERY TESTER, U.S. Ser. No. 60/341,902, filed Dec. 19, 2001, entitled BATTERY TESTER MODULE; U.S. Ser. No. 10/042,451, filed Jan. 8, 2002, entitled BATTERY CHARGE CONTROL DEVICE, U.S. Ser. No. 10/073,378, filed Feb. 8, 2002, entitled METHOD AND APPARATUS USING A CIRCUIT MODEL TO EVALUATE CELL/BATTERY PARAMETERS; U.S. Ser. No. 10/093,853, filed Mar. 7, 2002, entitled ELECTRONIC BATTERY TESTER WITH NETWORK COMMUNICATION; U.S. Ser. No. 60/364,656, filed Mar. 14, 2002, entitled ELECTRONIC BATTERY TESTER WITH LOW TEMPERATURE RATING DETERMINATION; U.S. Ser. No. 10/098,741, filed Mar. 14, 2002, entitled METHOD AND APPARATUS FOR AUDITING A BATTERY TEST; U.S. Ser. No. 10/112,114, filed Mar. 28, 2002; U.S. Ser. No. 10/109,734, filed Mar. 28, 2002; U.S. Ser. No. 10/112,105, filed Mar. 28, 2002, entitled CHARGE CONTROL SYSTEM FOR A VEHICLE BATTERY; U.S. Ser. No. 10/112,998, filed Mar. 29, 2002, entitled BATTERY TESTER WITH BATTERY REPLACEMENT OUTPUT; U.S. Ser. No. 10/119,297, filed Apr. 9, 2002, entitled METHOD AND APPARATUS FOR TESTING CELLS AND BATTERIES EMBEDDED IN SERIES/PARALLEL SYSTEMS; U.S. Ser. No. 60/379,281, filed May 8, 2002, entitled METHOD FOR DETERMINING BATTERY STATE OF CHARGE; U.S. Ser. No. 60/387,046, filed Jun. 7, 2002, entitled METHOD AND APPARATUS FOR INCREASING THE LIFE OF A STORAGE BATTERY; U.S. Ser. No. 10/177,635, filed Jun. 21, 2002, entitled BATTERY CHARGER WITH BOOSTER PACK; U.S. Ser. No. 10/200,041, filed Jul. 19, 2002, entitled AUTOMOTIVE VEHICLE ELECTRICAL SYSTEM DIAGNOSTIC DEVICE; U.S. Ser. No. 10/217,913, filed Aug. 13, 2002, entitled, BATTERY TEST MODULE; U.S. Ser. No. 60/408,542, filed Sep. 5, 2002, entitled BATTERY TEST OUTPUTS ADJUSTED BASED UPON TEMPERATURE; U.S. Ser. No. 10/246,439, filed Sep. 18, 2002, entitled BATTERY TESTER UPGRADE USING SOFTWARE KEY; U.S. Ser. No. 60/415,399, filed Oct. 2, 2002, entitled QUERY BASED ELECTRONIC BATTERY TESTER; and U.S. Ser. No. 10/263,473, filed Oct. 2, 2002, entitled ELECTRONIC BATTERY TESTER WITH RELATIVE TEST OUTPUT; U.S. Ser. No. 60/415,796, filed Oct. 3, 2002, entitled QUERY BASED ELECTRONIC BATTERY TESTER; U.S. Ser. No. 10/271,342, filed Oct. 15, 2002, entitled IN-VEHICLE BATTERY MONITOR; U.S. Ser. No. 10/310,515, filed Dec. 5, 2002, entitled BATTERY TEST MODULE; U.S. Ser. No. 10/310,490, filed Dec. 5, 2002, entitled ELECTRONIC BATTERY TESTER; U.S. Ser. No. 10/310,385, filed Dec. 5, 2002, entitled BATTERY TEST MODULE, U.S. Ser. No. 60/437,255, filed Dec. 31, 2002, entitled REMAINING TIME PREDICTIONS, U.S. Ser. No. 60/437,224, filed Dec. 31, 2002, entitled DISCHARGE VOLTAGE PREDICTIONS, U.S. Ser. No. 10/349,053, filed Jan. 22, 2003, entitled APPARATUS AND METHOD FOR PROTECTING A BATTERY FROM OVERDISCHARGE, U.S. Ser. No. 10/388,855, filed Mar. 14, 2003, entitled ELECTRONIC BATTERY TESTER WITH BATTERY FAILURE TEMPERATURE DETERMINATION, U.S. Ser. No. 10/396,550, filed Mar. 25, 2003, entitled ELECTRONIC BATTERY TESTER, U.S. Ser. No. 60/467,872, filed May 5, 2003, entitled METHOD FOR DETERMINING BATTERY STATE OF CHARGE, U.S. Ser. No. 60/477,082, filed Jun. 9, 2003, entitled ALTERNATOR TESTER, U.S. Ser. No. 10/460,749, filed Jun. 12, 2003, entitled MODULAR BATTERY TESTER FOR SCAN TOOL, U.S. Ser. No. 10/462,323, filed Jun. 16, 2003, entitled ELECTRONIC BATTERY TESTER HAVING A USER INTERFACE TO CONFIGURE A PRINTER, U.S. Ser. No. 10/601,608, filed Jun. 23, 2003, entitled CABLE FOR ELECTRONIC BATTERY TESTER, U.S. Ser. No. 10/601,432, filed Jun. 23, 2003, entitled BATTERY TESTER CABLE WITH MEMORY; U.S. Ser. No. 60/490,153, filed Jul. 25, 2003, entitled SHUNT CONNECTION TO A PCB FOR AN ENERGY MANAGEMENT SYSTEM EMPLOYED IN AN AUTOMOTIVE VEHICLE, U.S. Ser. No. 10/653,342, filed Sep. 2, 2003, entitled ELECTRONIC BATTERY TESTER CONFIGURED TO PREDICT A LOAD TEST RESULT, U.S. Ser. No. 10/654,098, filed Sep. 3, 2003, entitled BATTERY TEST OUTPUTS ADJUSTED BASED UPON BATTERY TEMPERATURE AND THE STATE OF DISCHARGE OF THE BATTERY, U.S. Ser. No. 10/656,526, filed Sep. 5, 2003, entitled METHOD AND APPARATUS FOR MEASURING A PARAMETER OF A VEHICLE ELECTRICAL SYSTEM, U.S. Ser. No. 10/656,538, filed Sep. 5, 2003, entitled ALTERNATOR TESTER WITH ENCODED OUTPUT, U.S. Ser. No. 10/675,933, filed Sep. 30, 2003, entitled QUERY BASED ELECTRONIC BATTERY TESTER, U.S. Ser. No. 10/678,629, filed Oct. 3, 2003, entitled ELECTRONIC BATTERY TESTER/CHARGER WITH INTEGRATED BATTERY CELL TEMPERATURE MEASUREMENT DEVICE, U.S. Ser. No. 10/681,666, filed Oct. 8, 2003, entitled ELECTRONIC BATTERY TESTER WITH PROBE LIGHT, which are incorporated herein in their entirety.

In general, prior art battery chargers include a charge indicator that lights up when the battery is charging. The light goes out when the charging is complete. When such chargers are employed, the charger user has to be proximate the battery charger if the user wishes to know the battery charge status. This may be inconvenient when the charger user has to carry out other tasks at locations that are remote from the charger.

### SUMMARY OF THE INVENTION

A battery charger with an automatic customer notification system is provided. The battery charger includes battery charging circuitry which is configured to couple to a battery, and to provide a charging signal to the battery. The battery charger also includes communication circuitry, coupled to the charging circuitry, that is configured to transmit a signal to an external device upon receipt of a charge status code form the battery charging circuitry.

### BRIEF DESCRIPTION OF THE DRAWINGS

FIG. 1 is a simplified block diagram illustrating a battery charger that includes a customer/user notification system in accordance with an embodiment of the present invention.

FIG. 2 is a simplified block diagram illustrating components of battery charging circuitry included in the battery charger of FIG. 1.

### DETAILED DESCRIPTION OF THE PREFERRED EMBODIMENTS

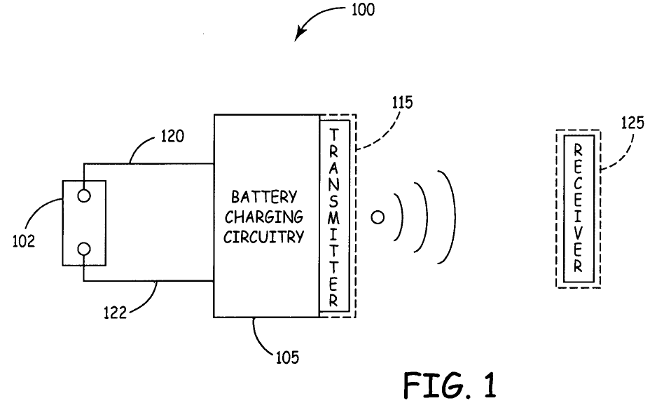

FIG. 1 is a simplified block diagram illustrating an example battery charger 100 that includes a customer/user notification system in accordance with an embodiment of the present invention. Battery charger 100 includes battery charging circuitry 105, which can couple to storage battery 102 through electrical connectors 120 and 122 to charge battery 102. As can be seen in FIG. 1, battery charger 100 also includes communication circuitry 115, coupled to charging circuitry 105, which includes a transmitter/transceiver. Communication circuitry 115 is capable of transmitting signals to an external device 125, which is located within the coverage area of communication circuitry 115. External device 125 includes a receiver. Charging circuitry 105, which is described in detail further below, provides a charge status code to communication circuitry 115 as soon as battery 102 is charged, for example. Upon receipt of the charge status code from charging circuitry 105, communication circuitry 115 sends a signal to external device 125, which in turn alerts the device user. Thus, the customer/user does not have to be proximate battery charger 100 to determine the charge status of battery 102.

In one embodiment, communication circuitry 115 broadcasts radio signals over a specific frequency. External device 125 is tuned to the same frequency broadcast from communication circuitry 115. In embodiments that include multiple external devices 125, each external device 125 has a specific identification sequence. External device 125 listens for its unique identification sequence. When it hears the unique identification sequence, it alerts the user and may provide additional information, depending on the external device type.

In some embodiments, external device 125 is a beeper or pager, which provides a basic alert to the user. Such beepers or pagers may light up, use audio signals or vibrate. In some embodiments, a combination of such alerts are provided. The pagers typically run on rechargeable batteries. In one embodiment, the receiver of external device (pager) 125 is a simple radio antenna, made from a coil of wire wrapped around a metal core, which picks up the signal from communication circuitry 115. This signal is sent to microprocessor (not shown) of device 125, where it is compared against the unique identification sequence for that pager. When the signal matches the unique identification sequence, the pager alerts the user using one or more of the above-mentioned three methods: audio, visual or vibratory.

An audio alert may be a tone or series of tones through a small piezoelectric speaker (not shown) mounted directly on a circuit board (not shown) of the pager. The audio alert may also be a prerecorded voice alert, such as “Your battery is charged.” A visual alert may be a series of LEDs flashing rapidly or simply lighting up. Vibration may be produced by a small DC motor (not shown) with a weight mounted off-center on the motor's spindle. When the motor spins the weight, the off-center mounting causes vibration.

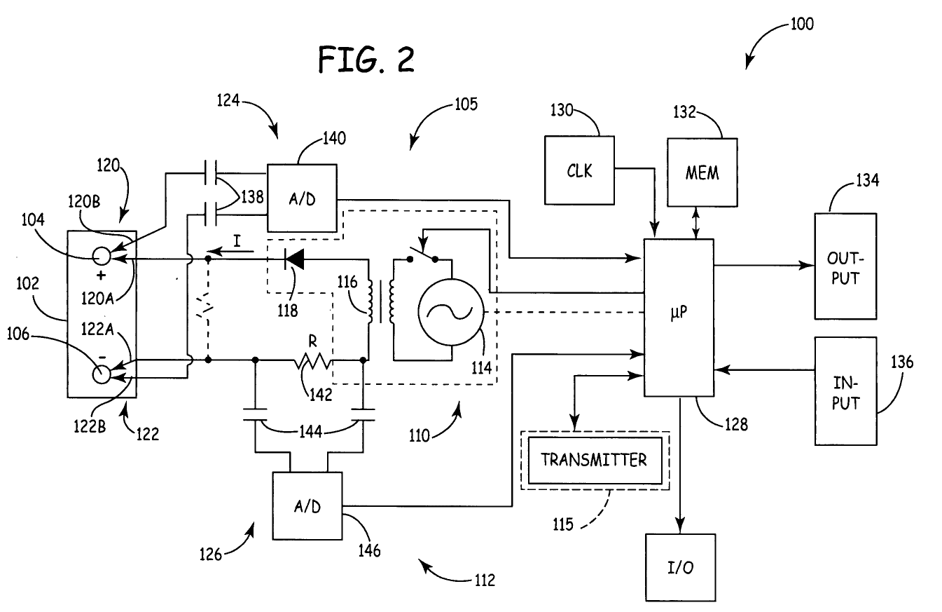

In the above-described embodiments, depending on the power of the transmitter within communication circuitry 115, the coverage area for customer notification can range from a few hundred feet to several miles. In some embodiments, communication circuitry 115 can be provided with a code corresponding to a particular external device 125 via input 136. Here, external device 125 may be a cell phone and the code may be a cell phone number. In such embodiments, communication circuitry 115 can provide the cell phone with information regarding the charge status of the battery. The information can appear as a text message on the cell phone. Details regarding components of battery charger 100 of FIG. 1 are provided below in connection with FIG. 2.

FIG. 2 is a simplified block diagram showing details of battery charging circuitry 105 of battery charging system 100. Battery charging circuitry 105 includes charge supply circuitry 110 and test circuitry 112. Charge supply circuitry 110 generally includes AC source 114, transformer 116 and rectifier 118. System 100 couples to battery 102 through electrical connection 120 which couples to the positive battery contact 704 and electrical connection 122 which couples to the negative battery contact 106. In one preferred embodiment, a four point (or Kelvin) connection technique is used in which charge supply circuitry 110 couples to battery 102 through electrical connections 120A and 122A while battery testing circuitry 112 couples to battery 102 through electrical connections 120B and 122B.

Battery testing circuitry 112 includes voltage measurement circuitry 124 and current measurement circuitry 126 which provide outputs to microprocessor 128. Microprocessor 128 also couples to a system clock 130 and memory 132 which is used to store information and programming instructions. In the embodiment of the present invention shown in FIG. 2, microprocessor 128 also couples to user output to circuitry 134 and user input circuitry 136. As can be seen in FIG. 2, microprocessor 128 is coupled to communication circuitry 115 and, as mentioned above, provides charge status codes to communication circuitry 115.

Voltage measurement circuitry 124 includes capacitors 138 which couple analog to digital converter 140 to battery 102 thorough electrical connections 120B and 122B. Any type of coupling mechanism may be used for element 138 and capacitors are merely shown as one preferred embodiment. Further, the device may also couple to DC signals. Current measurement circuitry 126 includes a shunt resistor (R) 142 and coupling capacitors 144. Shunt resistor 142 is coupled in series with battery charging circuitry 110. Other current measurement techniques are within the scope of the invention including Hall-Effect sensors, magnetic or inductive coupling, etc. An analog to digital converter 146 is connected across shunt resistor 142 by capacitors 144 such that the voltage provided to analog to digital converter 146 is proportional to a current I flowing through battery 102 due to charging circuitry 110. Analog to digital converter 146 provides a digitized output representative of this current to microprocessor 128.

During operation, AC source 114 is coupled to battery 102 through transformer 116 and rectifier 118. Rectifier 118 provides half wave rectification such that current I has a non-zero DC value. Of course, full wave rectification or other AC sources may also be used. Analog to digital converter 146 provides a digitized output to microprocessor 128 which is representative of current I flowing through battery 102. Similarly, analog to digital converter 124 provides a digitized output representative of the voltage across the positive and negative terminals of battery 102. Analog to digital converters 124 and 146 are capacitively coupled to battery 102 such that they measure the AC components of the charging signal.

Microprocessor 128 determines the conductance of battery 102 based upon the digitized current and voltage information provided by analog to digital converters 146 and 124, respectively. Microprocessor 128 calculates the conductance of battery 102 as follows:

$$\text{Conductance} = G = \frac{I}{V} \qquad Eq . 1$$

where I is the AC charging current and V is the AC charging voltage across battery 102. Note that in one preferred embodiment the Kelvin connections allow more accurate voltage determination because these connections do not carry substantial current to cause a resultant drop in the voltage measured.

The battery conductance is used to monitor charging of battery 102. Specifically, it has been discovered that as a battery is charged the conductance of the battery rises which can be used as feedback to the charger. This rise in conductance can be monitored in microprocessor 128 to determine the time remaining for the battery to be charged, when the battery has been fully charged, etc.

Microprocessor 128 can provide different charge status codes to communication circuitry 115 for time remaining for the battery to be charged and for battery charge complete indication. Communication circuitry 115 in turn provides suitable signals to external device 125. In some embodiments, device 125 can be a two-way pager which is capable of sending a charge status inquiry signal to the transmitter 115, which operates in conjunction with microprocessor 128 to provide the charge status information to the two-way pager.

It should be noted that instead of using radio frequency signals for communication between circuitry 115 and external device 125, infrared signals can also be used. In general, any wireless communication techniques known in the industry or that are developed in the future can be employed for communication between circuitry 115 and external device 125, without departing from the spirit or scope of the present invention.

Although the present invention has been described with reference to preferred embodiments, workers skilled in the art will recognize that changes may be made in form and detail without departing from the spirit and scope of the invention.

1. A battery charger comprising:
battery charging circuitry configured to couple to a battery, and to provide a charging signal to the battery; and
communication circuitry, coupled to the charging circuitry, configured to transmit a signal to an external device upon receipt of a charge status code form the battery charging circuitry.

2. The battery charger of claim 1 including a Kelvin connection configured to couple to the battery.

3. The battery charger of claim 1 wherein the charge status code indicates that the battery charge is complete.

4. The battery charger of claim 1 wherein the charge status code is indicative of a time remaining for the battery to be completely charged.

5. The battery charger of claim 1 wherein the external device, to which the communication circuitry is configured to transmit the signal, is a pager configured to provide a user with an audio alert.

6. The battery charger of claim 1 wherein the external device, to which the communication circuitry is configured to transmit the signal, is a pager configured to provide a user with a visual alert.

7. The battery charger of claim 1 wherein the external device, to which the communication circuitry is configured to transmit the signal, is a pager configured to vibrate.

8. The battery charger of claim 1 wherein the external device, to which the communication circuitry is configured to transmit the signal, is a two-way pager.

9. The battery charger of claim 1 wherein the external device, to which the communication circuitry is configured to transmit the signal, is a cell phone configured to provide a text message regarding a charge status of the battery.

10. The battery charger of claim 1 wherein the signal, that the communication circuitry is configured to transmit, is a radio frequency signal.

11. The battery charger of claim 1 wherein the signal, that the communication circuitry is configured to transmit, is an infrared signal.

12. A method comprising:
providing battery charging circuitry configured to couple to a battery, and to provide a charging signal to the battery; and
providing communication circuitry, coupled to the charging circuitry, configured to transmit a signal to an external device upon receipt of a charge status code form the battery charging circuitry.

13. The method of claim 12 further comprising providing a Kelvin connection configured to couple to the battery.

14. The method of claim 12 wherein the charge status code indicates that the battery charge is complete.

15. The method of claim 12 wherein the charge status code is indicative of a time remaining for the battery to be completely charged.

16. The method of claim 12 wherein the external device, to which the communication circuitry is configured to transmit the signal, is a pager configured to provide a user with an audio alert.

17. The method of claim 12 wherein the external device, to which the communication circuitry is configured to transmit the signal, is a pager configured to provide a user with a visual alert.

18. The method of claim 12 wherein the external device, to which the communication circuitry is configured to transmit the signal, is a pager configured to vibrate.

19. The method of claim 12 wherein the external device, to which the communication circuitry is configured to transmit the signal, is a two-way pager.

20. The method of claim 12 wherein the external device, to which the communication circuitry is configured to transmit the signal, is a cell phone configured to provide a text message regarding a charge status of the battery.

21. The method of claim 12 wherein the signal, that the communication circuitry is configured to transmit, is a radio frequency signal.

22. The method of claim 12 wherein the signal, that the communication circuitry is configured to transmit, is an infrared signal.
